(19) United States
(12) Patent Application Publication
(10) Pub. No.: US 2023/0044463 A1
(43) Pub. Date: Feb. 9, 2023

(54) SYSTEM AND METHOD FOR LOCATING PRODUCTS

(71) Applicant: Referboard Marketing Pty Ltd, Heidelberg (AU)

(72) Inventor: Aaron WOOLF, Heidelberg (AU)

(73) Assignee: Referboard Marketing Pty Ltd, Heidelberg (AU)

(21) Appl. No.: 17/126,746

(22) Filed: Dec. 18, 2020

Related U.S. Application Data
(60) Provisional application No. 62/951,107, filed on Dec. 20, 2019.

(51) Int. Cl. G06Q 30/06; G06F 16/22; G06F 16/242

(52) U.S. Cl. CPC G06Q 30/0625; G06F 16/22; G06F 16/242

(57) ABSTRACT

A distributed computing system (10) for locating product, comprising: a plurality of user devices (19); a product server (18) in communication over a network (15) with the plurality of user devices (19); and a product database (16) storing product data corresponding to a plurality of products, wherein each user device (19) is configured to: receive a user input to share an image with the product server (18); extract image data corresponding to the image from an image data source (13); and transmit the extracted image data to the product server (18), and wherein the product server (18) is configured to: in response to receiving the image data from one of the plurality of user devices (19), retrieve the image from an image source (12) based on the received image data; match the retrieved image with at least one of a plurality of products based on the product data stored in the product database (16); and transmit product data corresponding to the at least one product to the one of the plurality of user devices (19) in order to enable the one of the plurality of user devices (19) to display information relating to the at least one product.

### CROSS REFERENCE TO RELATED PATENT APPLICATIONS

The present application claims priority benefit, under 35 U.S.C. §119(e), to co-pending and commonly-assigned U.S. Patent Application No. 62/951,107, filed on Dec. 20, 2019, entitled “A SYSTEM AND METHOD FOR LOCATING PRODUCTS,” listing as inventor Aaron Woolf, which application is herein incorporated by reference as to its entire content. Each reference mentioned in this patent document is incorporated by reference herein in its entirety.

### FIELD

The invention relates to a system and method for locating products.

### BACKGROUND

Many retailers provide online stores that allow customers to purchase products that are available in the physical stores of the retailers. Products from such online stores are not always locatable by general web or Internet search engines.

Online marketplaces (such as Amazon (trade mark)) provide a platform by which products from different retailers can be available for purchase. Before a retailer can offer a product on an online marketplace, the retailer must usually provide some form of product data such as the name of the product. Such product data allow online marketplaces to locate relevant products.

When searching for specific products in such online marketplaces, keywords are often used by users. A keyword is usually directly input by a user, for example, by typing the keyword on a user device (such as a smartphone) or voicing the keyword for recognition by the user device. In this respect, it is known that an image captured by a user device can be processed by the user device to generate a keyword for locating products on an online marketplace.

When products located from such searches are displayed to users, an image or images of each located product is sometimes also displayed. Depending on the keyword, the products displayed to a user may or may not correspond to the specific product the user is searching for.

There is a need for alternative or improved features.

### SUMMARY OF THE INVENTION

The invention provides a distributed computing system (10) for locating products, comprising:

a plurality of user devices (19);

a product server (18) in communication over a network (15) with the plurality of user devices (19); and

a product database (16) storing product data corresponding to a plurality of products

wherein each user device (19) is configured to:

receive a user input to share an image with the product server (18);

extract image data corresponding to the image from an image data source (13); and

transmit the extracted image data to the product server (18), and wherein the product server (18) is configured to:

in response to receiving the image data from one of the plurality of user devices (19), retrieve the image from an image source (12) based on the received image data;

match the retrieved image with at least one of a plurality of products based on the product data stored in the product database (16); and

transmit product data corresponding to the at least one product to the one of the plurality of user devices (19) in order to enable the one of the plurality of user devices (19) to display information relating to the at least one product.

In an embodiment, the image data extracted by each user device (19) comprises an identifier of an image.

In an embodiment, the identifier is a Uniform Resource Locator (URL).

In an embodiment, each user device (19) is configured to retrieve an image from the image source (12) for display on a display of the user device (19).

In an embodiment, the image source (12) is an external computing system in communication over a network (15) with each user device (19).

In an embodiment, the product server (18) is in communication with a plurality of external computing systems (11), and is configured to receive product data from each of the plurality of external computing systems (11).

In an embodiment, the product server (18) is configured to index the product data received from the plurality of external computing systems (11).

In an embodiment, the product server (18) is configured to recognize at least one characteristic from the retrieved image, and

wherein the retrieved image is matched with the at least one of the plurality of products based on the at least one characteristic.

In an embodiment, the product server (18) is configured to generate a modified image comprising at least one selectable portion corresponding respectively to the at least one product.

In an embodiment, the product data transmitted from the product server (18) to the one of the plurality of user devices (19) comprises the modified image, and at least one identifier corresponding respectively to the at least one product.

The invention also provides a method of locating products, comprising:

receiving a user input at one of a plurality of user devices (19) to share an image with a product server (18) in communication over a network (15) with each user device (19);

extracting image data corresponding to the image from an image data source (12);

transmitting the image data from the one of the plurality of user devices (19) to the product server (18);

in response to receiving the image data, retrieving the image from an image source (12) based on the received image data;

matching the retrieved image with at least one of a plurality of products based on product data corresponding to a plurality of products stored in a product database (16); and

transmitting product data corresponding to the at least one product to the one of the plurality of user devices (19) in order to enable the one of the plurality of user devices (19) to display information relating to the at least one product.

In an embodiment, the image data transmitted by each user device (19) comprises an identifier of the image that is determined by the user device (19).

In an embodiment, the identifier is a Uniform Resource Locator (URL).

In an embodiment, the method comprises retrieving an image from the image source (12) for display on a display of the user device (19).

In an embodiment, the image source (12) is an external computing system in communication over a network with each user device (19).

In an embodiment, the product server (18) is in communication with a plurality of external computing systems (11), and

wherein the method comprises receiving product data from each of the plurality of external computing systems (11).

In an embodiment, the method comprises indexing the product data received from the plurality of external computing systems (11).

In an embodiment, the product server (18) is configured to recognize at least one characteristic from the retrieved image, and

wherein the retrieved image is matched with the at least one of the plurality of products based on the at least one characteristic.

In an embodiment, the product server (18) is configured to generate a modified image comprising at least one selectable portion corresponding respectively to the at least one product.

In an embodiment, the product data transmitted from the product server (18) to the one of the plurality of user devices comprises the modified image, and at least one identifier corresponding respectively to the at least one product.

In an embodiment, the product data transmitted from the product server (18) to the one of the plurality of user devices comprises the modified image, and at least one identifier corresponding respectively to the at least one product.

The invention also provides a product server (18) for locating products, comprising:

a transceiver (1890);

a processor (1800);

a memory (1880) storing executable code that when executed by the processor (1800) causes the product server (19) to:

receive, via the transceiver (1890), from one of a plurality of user devices (19) in communication over a network (15) with the product server (18) image data extracted from an image data source (13);

retrieve, via the transceiver (1890), an image corresponding to the received image data from an image source (12) based on the received image data;

match the retrieved image with at least one of a plurality of products based on product data stored in a product database (16) in communication with the product server (18); and

transmit, via the transceiver (1990), product data corresponding to the at least one product to the one of the plurality of user devices (19) in order to enable the one of the plurality of user devices (19) to display information relating to the at least one product.

The invention also provides a user device (19) for locating products, comprising:

a user input device (1930);

a user display (1950);

a transceiver (1990);

a processor (1900);

a memory (1980) storing executable code that when executed by the processor (1900) causes the user device (19) to:

receive, via the user input device (1930), a user input to share an image with a product server (18) in communication over a network (15) with the user device (19);

in response to receiving the user input,

extract image data for enabling the product server (18) to retrieve image from an image source (12), wherein the image data corresponds to the image; and

transmit, via the transceiver (1990), the extracted image data to the product server (18);

receive, via the transceiver (1990), from the product server (18) product data that is generated based the transmitted image data, wherein the product data corresponds to at least one product matching the image; and

in response to receiving the product data, display information relating to the at least one product on the user display (1950).

### BRIEF DESCRIPTION OF THE DRAWINGS

In order that the invention may be more clearly ascertained, embodiments will now be described, by way of example, with reference to the accompanying drawings, in which:

FIG. 1 is a schematic diagram of the physical architecture of an embodiment of the distributed computing system 10 for locating products;

FIG. 2 is a schematic diagram of the functional components of the distributed computing system 10 of FIG. 1;

FIG. 3 is a schematic diagram of the sub-components of one of the functional components of FIG. 2;

FIG. 4 is a flow chart of an embodiment of the method of locating products, that may be carried out using the distributed computing system 10 of FIGS. 1, 2 and 3;

FIG. 5 is a flow chart of specific steps that may occur when performing one of the steps of the method of FIG. 4;

FIG. 6 is a screenshot of a user device 19 of an embodiment of the distributed computing system 10 of FIGS. 1, 2 and 3 displaying a user interface of a smartphone app comprising a plurality of images, and a screenshot of source code corresponding to the user interface;

FIG. 7 is a flow chart of an embodiment of a method of collecting product data and an embodiment of the method of locating matching products, that may be carried out using the distributed computing system 10 of FIGS. 1, 2 and 3;

FIG. 8 is a flow chart of a method of making online purchases of products involving an embodiment of the method of locating matching products, that may be carried out using the distributed computing system 10 of FIGS. 1, 2 and 3; and

FIG. 9-11 are screenshots of a user device of an embodiment of the distributed computing system 10 of FIGS. 1, 2 and 3.

FIG. 12 is a flow diagram of a method for recommending products to a user based on an image provided by a user.

FIG. 13 shows an example image provided by a user.

FIG. 14 is an example representation of three component numerical metric arrays representing the image of FIG. 14.

FIG. 15 illustrates the AI scanning process of the images of FIG. 14.

FIG. 16 shows a detected object and associated bounding box data.

FIG. 17 is an example representation of three component numerical metric arrays representing the image of FIG. 16.

FIG. 18 is an illustration of a deep learning algorithm.

FIG. 19 is an illustration of AI embeddings.

FIG. 20 shows cosine similarity between embedding vectors.

FIG. 21 shows an index table including product information and embedding vectors.

FIG. 22 shows the distance between the target object and products of the product database.

FIG. 23 shows the products ranked in order of similarity.

FIG. 24 shows data associated with ranked products.

FIG. 25 shows product recommendations in JSON format.

FIG. 26 shows representation of results within a UI.

### DETAILED DESCRIPTION

Referring to the drawings, there is shown embodiments of a distributed computing system 10 for locating one or more products (which may be in the form of a good, a service, or both a good and a service). The system 10 comprises a plurality of user devices 19 (for example, a mobile computing device such as a smartphone and a portable computer such as a tablet computer), and a product server 18 in communication over a network 15 with the user devices 18.

Each user device 19 is capable (for example, by way of a smartphone app installed on the user device 19) of receiving a user input (which may be in the form of a single touch or multiple touches on a touchscreen) to share an image (which may be derived from a video, an animated image etc) with the product server, extracting image data (which may include video data and animated image data) corresponding to the image from an image data source 13, and transmitting the extracted image data to the product server 18.

The product server 18 can receive image data from any one or more of the user devices 19. When the product server 18 receives image data from a user device 19, the product server 18 retrieves an image corresponding to the image data from an image source (which is usually, but not necessarily always, the same image source 12), and then matches the retrieved image with at least one product based on product data stored in a product database 16.

After locating one or more products that match the retrieved image, the product server 18 transmits product data corresponding to the matching product or products to the user device 19 from which the image data is received.

Because products (such as those corresponding to the product data stored in the product database 16) are matched directly to an image in respect of (for example, an image comprising) a relevant product (that is, a product that the user of a user device 19 has confirmed is relevant), the distributed computing system 10 is likely to locate products that are more relevant when compared to any alternative system that locates products indirectly such as an alternative system that locates products based on a keyword (for example, a descriptive word of the relevant product which is input by a user or a keyword that is derived by the alternative system from an image).

In contrast to a system that relies on a smartphone to generate a keyword (for example by identifying or recognizing a relevant product) from an image, the distributed computing system 10 merely requires each user device 19 to extract and transmit to the product server image data corresponding to the image. By distributing complex processing (such as the processing required to match the products in the product database) to the product server 18, the distributed computing system 10 is likely to be more efficient in locating products when compared to a system that relies on a smartphone to perform complex processing.

In this respect, a person skilled in the art will also appreciate that processing at the product server 18 in such a way is also additionally advantageous in that product data from a large number of external computing systems 11 can be centralized (for example, normalized or standardized in storage by way of using the same indexing or formatting) at the product database 16, the product server 18, or both the product database 16 and the product server 18.

It is envisaged that each of the user devices 19 and the product server 18 of the distributed computing system 10 is typically implemented by a computing device in data communication with a plurality of other computing devices. Examples of such a computing device include a computer server, a desktop personal computer, a portable computer (such as a laptop computer, a notebook computer or a tablet computer), a mobile computing device (such as a smartphone), a programmable circuit etc. Persons skilled in the art will appreciate that the system may be implemented by multiple computing devices such that each computing device implements only a part or parts of the system.

Also, it is envisaged that an embodiment of the distributed computing system 10 may locate products based on multiple images (rather than a single image), animated image or images, and/or one or more videos. For example, it is envisaged that, in an embodiment of the distributed computing system, a user device may share an animated image in the form of an animated Graphics Interchange Format (GIF) with the product server 18, and the product server 18 may retrieve and then match the animated GIF with at least one product based on product data (which may be only a subset of the product data such as product data including only animated GIFs, or all product data) stored in a product database 16.

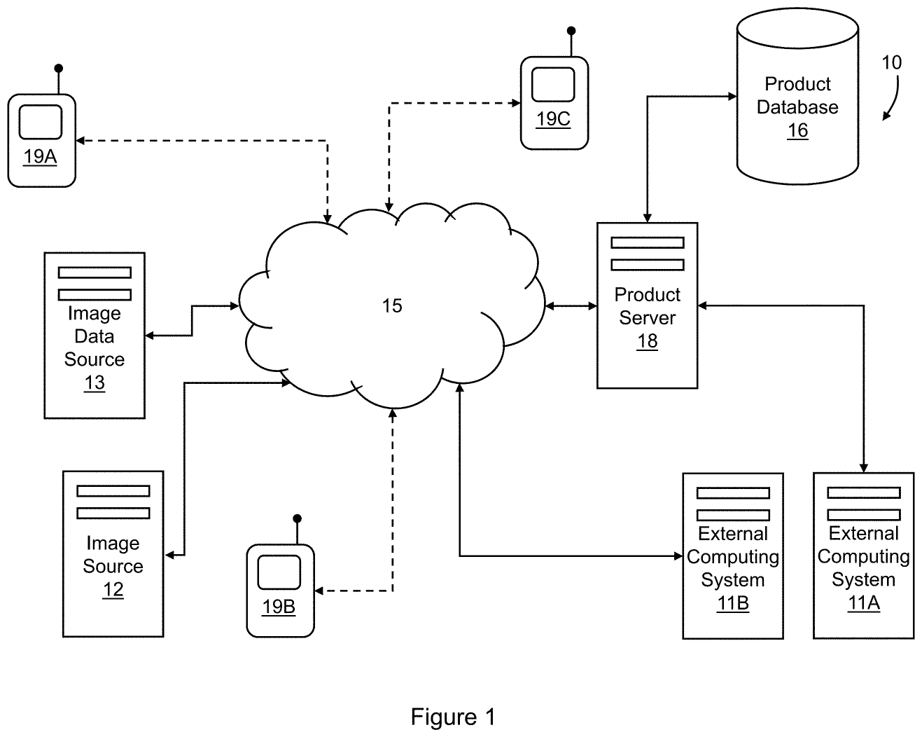

FIG. 1 is a schematic diagram of the physical architecture of an embodiment of the distributed computing system 10 for locating products. The distributed computing system 10 comprises a plurality of user devices in the form of smartphones 19A, 19B, 19C and a product server 18 in communication over a network in the form of the Internet 15 with the plurality of smartphones 19A, 19B, 19C. The product server 18 is also in communication over the Internet 15 with an external computing system in the form of an image source 12 storing one or more images.

Each of the smartphones 19A, 19B, 19C is in communication over the Internet 15 with an external computing system in the form of an image data source 13 which provides a social networking service and website Instagram (trade mark) and the image source 12.

Persons skilled in the art will appreciate that the image data source 13 may not provide a social networking service in an alternative embodiment of the distributed computing system 10. For example, the distributed computing system 10 may be connected to an image data source 13 providing personal user websites.

It is envisaged that the product server 18 may be connected to more than image data source 13, more than one image source 12, or both. Also, it is envisaged that the image data source 15 and the image source 12 may be parts of the same external computing system.

The product server 18 is connected to an external computing system in the form of a retail computing system 11A. The product server 18 is also in communication over the Internet 15 with an external computing system in the form of another retail computing system 11B. This other retail computing system 11B provides an online retail website on which products are available for purchase. In contrast, the more directly connected retail computing system 11A provides an affiliate platform on which products available for purchase on online retail websites of multiple retailers may be listed. It is envisaged that a retail computing system 11 may be provided by any vendor or retailer including any affiliate market or marketplace (such as Amazon (trade mark), Rakuten (trade mark)) and Farfetch (trade mark)).

The product server 18 is connected to a product database 16 storing product data of a plurality of products. In this example, the product data of each product includes a link (such as a Uniform Resource Locator (URL), a Uniform Resource Identifier (URI), or some other form of web address) to a retailer's online store that allows a user to purchase the product. Product data with respect to a product may be added to the product database 16 by either a retailer from the retail computing system 11A connected to the product server 18, or a user of the product server 18 from the retail computing system 11B in communication over the Internet 15 with the product server 18.

Persons skilled in the art will appreciate that the product database 16 and the product server 18 may be parts of the same computing system. In this respect, it is envisaged that such a computing system may also include other devices or systems. For example it is envisaged that an alternative embodiment of the distributed computing system 10 may include a persistent disk or file storage to store all image objects with content delivery, caching and replication features such that images may be delivered to user devices 19 located in different regions with low latency. Persons skilled in the art will appreciate that the product data received or added from the first retail computing system 11A may be different or the same when compared to the product data received or added from the second retail computing system 11B. The product database 16 may be implemented using a programming language designed for managing data such as Structured Query Language (SQL) or may be implemented using other programming language or languages.

A smartphone 19 can communicate with the product server 18 by way of one or more software applications installed on the smartphone 19. For example, the software app may be a smartphone app 19, a web browser plugin, or both. Depending on the embodiment, a user may be required to provide one or more user identifiers (for example, a username and password) in order to install, use, or both install and use the smartphone app.

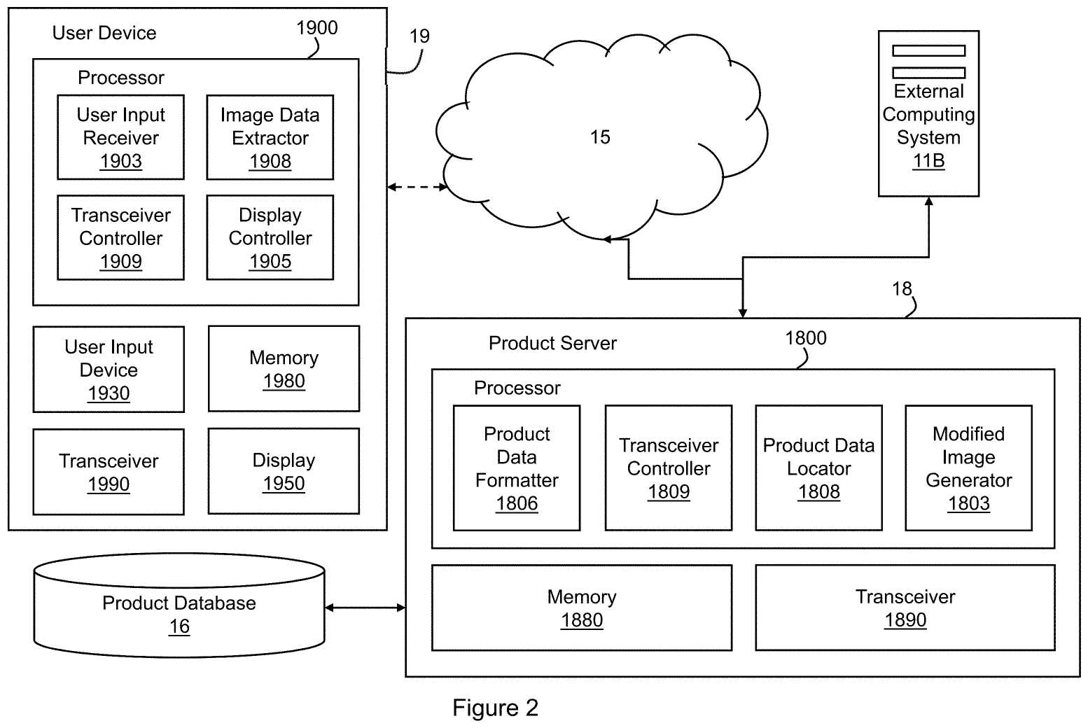

FIG. 2 is a schematic diagram showing more specific components of each smartphone or user device 19 and the product server 18 of the distributed computing system 10. Beginning first with the smartphones 19, each one of the smartphones 19 comprises a user input device 1930, a display 1950, a transceiver 1990, a processor 1900 and memory 1980 for storing a smartphone app for communicating with the product server 18 such that the smartphone 19 can share an image with the product server 18 to enable the distributed computing system 10 to locate products.

The display 1950 of each smartphone or user device 19 allows the smartphone or user device 19 to display one or more images such as an Instagram image transmitted from the image source 12. The user input device 1930 of each smartphone or user device 19 allows the smartphone 19 to receive from a user some form of user input to share the image. The user input device 1930 and the display 1950 are implemented typically by way of a touchscreen. However, it is envisaged that this is not necessarily always the case with every embodiment of the distributed computing system 10. In particular, a person skilled in the art will appreciate that the user input device 1930 and the display 1950 may be two different devices. For example, the user input device 1930 may alternatively be any suitable user input device such as a keyboard, a mouse, or a keyboard and a mouse.

Each smartphone or user device 19 and the product server 18 of the distributed computing system 10 comprises a number of functional components for locating products. It is envisaged that the functional components are typically implemented by a processor executing program code and data stored in a memory. However, persons skilled in the art will appreciate that this need not be the case. For example, one or more of the components could be implemented in an alternative manner, for example, as a dedicated circuit.

It is envisaged that once the smartphone app for communicating with the product server 18 is installed on the smartphone 19 for execution, the processor 1900 can execute the smartphone app stored in the memory 1980.

One of the functional components that the processor 1900 is configured to implement upon execution of the smartphone app is a transceiver controller 1909 arranged to control the transceiver 1990 of the smartphone or the user device 19 to retrieve, from the image source 12, an image for display on the display 1950 of the user device 19. A person skilled in the art will appreciate that the transceiver controller 1909 can be arranged to control the transceiver 1990 to automatically retrieve other types of data and perform other types of data transmissions. It is envisaged that the transceiver controller 1909 is configured to retrieve the image in response to user input.

Another functional component that the processor 1900 is configured to implement is a display controller 1905 that is arranged to control the display 1950 to display an image such as the retrieved image. Like with the retrieval of the image controlled by the transceiver controller 1909, the display controller 1905 may automatically display the retrieved image upon retrieval of the image by the user device 19 or do so in response to user input.

The processor 1900 is also configured to implement a user input receiver 1903 arranged to receive a user input to share an image with the product server from the user input device 1930. Such an implementation may be done automatically upon installation or only after manual execution of the smartphone app by a user of the user device or smartphone 19. Also, the processor 1900 is configured to implement an image data extractor 1908 that is configured to extract an identifier of the image. In this example, the identifier is a URL that is provided by the image data source 13 (that is, Instagram).

In an embodiment of the distributed computing system 10 where the user device 19 can communicate with the product server 18 by way of a web browser plugin, the image data extractor 1908 may be provided by way of a program script that is executed when a user operating a user device or smartphone 19 clicks on a button or icon associated with the web browser plugin when web browsing. An example of the program script that is written in JavaScript (trade mark) is provided below.

<a href=“javascript:void(0);” data-imageurl=“https://instagram.fme18-
1.fna.fbcdn.net/vp/17924c17912eaee98df86531a9cbc271/5E27B5FE/t51.2885-15/
sh0.08/e35/s640x640/69875617_394804808101267_6976467248571567608_n.jpg?_nc_ht=
instagram.fme18-1.fna.fbcdn.net&_nc_cat =107” class=“img-tag” style=“width: calc(25%-15 px);
margin-bottom: 15 px;”>

The distributed computing system 10, the web browser plugin, one activated after installation on the user device 19, will automatically scan a webpage that is loaded on a web browser and then extract the URL of each image of the loaded webpage. More specifically, the executed web browser plugin will parse each image URL from web elements such as “<img>” and “<iframe>”. It is envisaged that the web browser plugin may extract all, some, or a selection of the images of a webpage depending on the embodiment of the distributed computing system 10.

It is envisaged that the user input receiver 1903 may be an icon or button that a user may activate or select on a user interface of a web browser app in this embodiment of the distributed computing system 10 where the user device 19 can communicate with the product server 18 by way of a web browser plugin. However, a person skilled in the art will appreciate that graphic user interface (GUI) elements other than buttons or icons may be provided. Persons skilled in the art will also appreciate that text may be provided in place of the buttons. Also, persons skilled in the art will appreciate that the user input receiver 1903 may be implemented in some other manner such as a keyboard shortcut.

In an embodiment of the distributed computing system 10 to the above-mentioned embodiment where the user device 19 can communicate with the product server 18 by way of a web browser plugin, the user input receiver 1903 can be arranged to receive a user input to share an image with the product server from the user input device 1930 using multiple smartphone apps. In this embodiment, a smartphone app for enabling such sharing, once installed on the user device 19, will enable one or more existing smartphone apps (for example, the Instagram (trade mark) app) to share an image or images from any webpage with the product server 18. Further details of an example of such an image sharing enabling smartphone app will be described below.

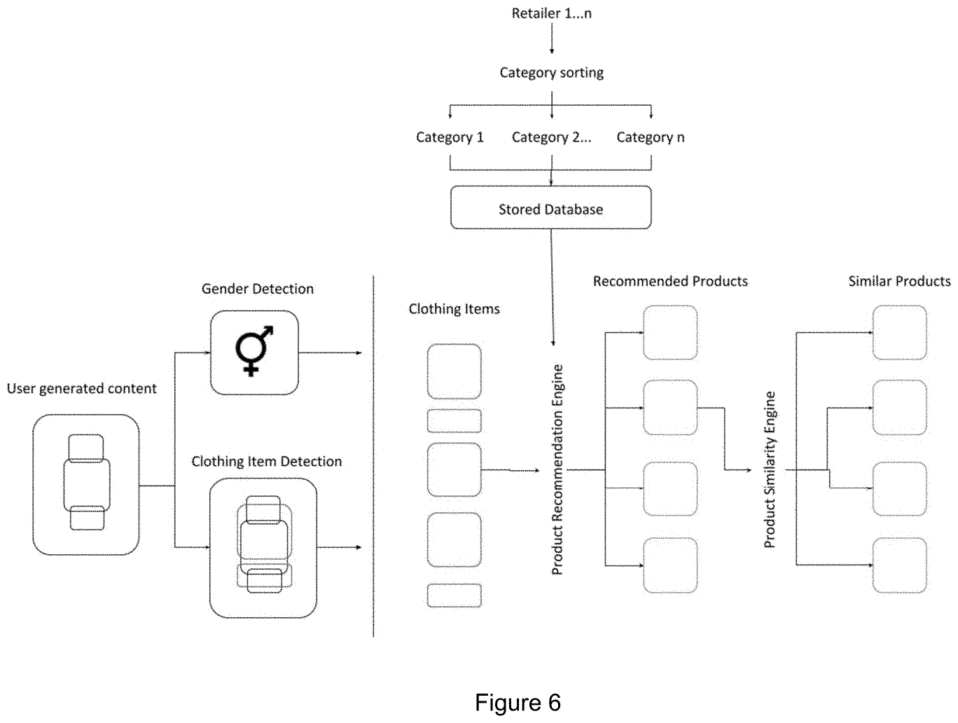

An example of the above-mentioned parsing and extracting process of an embodiment is illustrated in FIG. 6. The left side of FIG. 6 shows a user's webpage from the user interface of the Instagram (trade mark) app. The right side of the FIG. 6 shows the webpage's source code. It is envisaged that the source code for displaying the webpage is the same irrespective of whether the webpage is loaded from the Instagram (trade mark) app or from another suitable app such as a web browser.

Once activated, the user's webpage is displayed on the Instagram (trade mark) app and the source code of the webpage is scanned (for example, directly by the image sharing enabling smartphone app) in order to search for any “<img>” or equivalent web elements (in the red box on the right side of FIG. 6) in the source code. In such web elements, attributes such as “src” indicate URLs of images. Once such attributes are found, the value of each “src” or equivalent is parsed as an image URL. Accordingly, each user device 19 would merely need to load the user's webpage on the Instagram (trade mark) app, and then a user will merely have to select all or some of the images on the webpage using the user device or smartphone 19 to share the selected images with the product server 18 using the image sharing enabling smartphone app.

As indicated above, the identifier of the image extracted by the image data extractor 1908 of this embodiment of the distributed computing system 10 is a URI or a URL. However, it is envisaged that the identifier may not be a URI or a URL. For example, in an embodiment of the distributed computing system 10, the identifier may be Base64-encoded text (or in some other format), or simply a filename of the image. Also, in addition to the above-mentioned image sharing enabling smartphone app and the above-mentioned web browser plugin, it is envisaged that an embodiment of the distributed computing system 10 may involves a user device 19 that has a user device camera app that may directly share an image taken by the user device camera app. It is envisaged that one or both of the image sharing enabling smartphone app and the above-mentioned web browser plugin may be installed on the same user device 19.

In addition to retrieving images, the transceiver controller 1909 is also arranged to control the transceiver 1990 to transmit the identifier (for example, the URI or the URL) from the user device 19 over the Internet 15 to the product server 18. For example, in the above embodiments of the distributed computing system 10 where the user device 19 can communicate with the product server 18 by way of a web browser plugin or some other an image sharing enabling app, image URLs of all, some or selected images extracted by the image data extractor 1908 may be sent through the Hypertext Transfer Protocol (HTTP) protocol via a rest Application Programming Interface (API) call (such as a POST API request) to the product server 18.

Persons skilled in the art will appreciate that the image data extracted and transmitted by one user device 19A may be different or the same when compared to the image data extracted and transmitted by another user device 19B. Also, it is envisaged that the display controller 1905 may be configured not only to display a retrieved image. For example, it is envisaged that the display controller 1905 of a user device or smartphone 19 is typically also configured to display a “pop-up” of an icon upon the user device or smartphone 19 receiving a request to share an image.

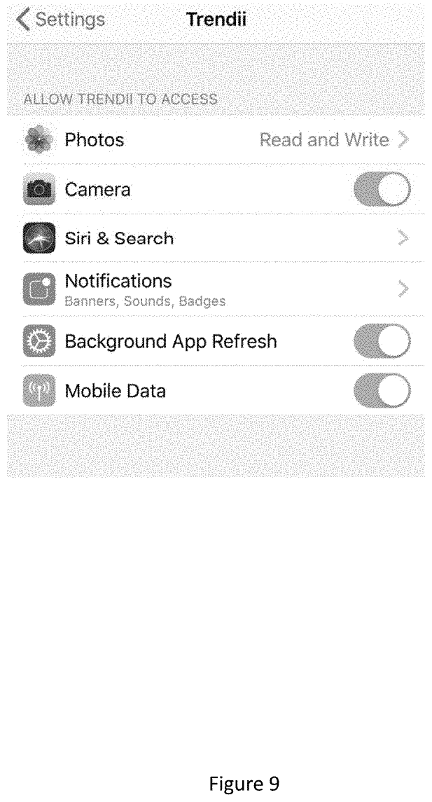

It is envisaged that the image sharing enabling app mentioned in any one of the above embodiments may involve additional any one of the functional components to perform additional functions. For example, in an embodiment where a camera app of a user device 19 may be used to share an image, the image sharing enabling app may be arranged to request a user to provide permission for the image sharing enabling app to have access to images captured by the camera app in order to share the image. A screenshot of a user device 19 displaying a user interface to provide such a permission is illustrated in FIG. 9.

Also, it is envisaged that the processor 1900 of a user device 19 18 may implement separate functional components for performing the operations performed by the transceiver controller 1909, in addition to or as an alternative to the above-mentioned transceiver controller 1909. For example, as an alternative to the above-mentioned transceiver controller 1909, the processor 1900 of a user device or smartphone 19 may, once a smartphone app for enabling image sharing with the product server 18 is installed in the smartphone 19, implement an identifier transmitter that is configured to control the transceiver 1990 to transmit the identifier from the user device 19 over the Internet 15 to the product server 18.

Turning now to the product server 18, the product server 18 comprises a transceiver 1890, a processor 1800 and memory 1880 for storing program code and data for enabling the processor to implement one or more functional components of the product server 18. Like with each user device 19, it is envisaged that the functional components may alternatively be implemented in some other manner such as a dedicated circuit.

Firstly, the processor 1800 of the product server 18 is configured to implement a transceiver controller 1809 that is arranged to control the transceiver 1890 of the product server 18 to receive product data from each of the retail computing systems 11, and to transmit the product data to the product database 16 for storage. Depending on which one of the retail computing systems 11 the product server 18 is receiving product data from, the transceiver controller 1809 may control the transceiver 1890 of the product server 18 to receive the product data using different protocols, different communication mediums, or both different protocols and different communication mediums.

The processor 1800 of the product server 18 is configured to implement a product data formatter 1806 configured to format the received product data before the formatted product data is transmitted to the product database 16 for storage. It is envisaged that such formatting may include data processing other than changing the format of the product data itself such as indexing the product data in some way such that the product data when stored in the product database 16 is efficiently retrievable by the product server 18. It is envisaged that, in an embodiment of the distributed computing system 10, the product server 18 may be configured to perform product data cleansing procedures (for example, rule based fixes on free text fields) to make sure that product data is correctly stored in the product database 16. After parsing and cleaning, product data stored in the product database 16 may then be indexed to make sure that the product data can be efficiency retrieved by the product server 18 for forwarding to user devices 19.

It is envisaged that the product data received from the retail computing systems 11 may comprise one or more details relating to products (which as indicated above may correspond to the same products that are for sale from a retailer's online store). For example, the product data of a product from a retail computing system 11 may comprise a link (for example, a URL) to an image of the product, a name of the product, a category of the product, a price of the product etc.

Depending on the embodiment, the server transceiver controller 1809 may be configured to download or retrieve an image of a product (for example, from retail computing system 11 or elsewhere such as an image source) if product data received by the product formatter 1806 from a retail computing system 11 indicates that such an image is available.

For example, in the above embodiments of the distributed computing system 10 where the user device 19 can communicate with the product server 18 by way of a web browser plugin or some other an image sharing enabling app, once the product server 18 receives a URI via an API call, the image may be downloaded based on the received URL and then saved, for example, temporarily and locally at the product server 18 (such as a persistent disk or storage for caching purpose) or alternatively in the product database 16.

Thus, any images of products stored at the product server 18 or in the product database 16 may be subsequently transmitted by the product server 18 directly to any one of the user devices 19.

When product data of a product is received from a retail computing system 11, the product formatter 1806 is configured to parse (and optionally normalise) the product data into one or more predetermined categories such that the formatted product data is suitable for storage in the product database 16. Accordingly, in an embodiment of the distributed computing system 10, a product may be tagged to at least one predetermined category based on a number of logics and multiple fields of product data.

Any image or data that is subsequently retrieved or downloaded by the server transceiver controller 1809 after product data of a product is received from a retail computing system 11 may also be parsed (and if necessary normalised) by the product formatter 1806 before the image or the data is stored in the product database 16.

When the transceiver controller 1809 receives an identifier (that is, a URL) of an image from a user device 19, the transceiver controller 1809 is configured to control the server transceiver to 1890 automatically retrieve the image from the image source 12 via the Internet 15. Thus, the distributed computing system 10 may be advantageous in that the product server 18 requires merely an identifier such as a URL of an image (as opposed to a system that requires the image itself which in turn will likely lead to additional complexity, such as an additional requirement for each user device to have some form of image capturing mechanism or further requiring multiple separate applications for capturing images and locating products) to locate products.

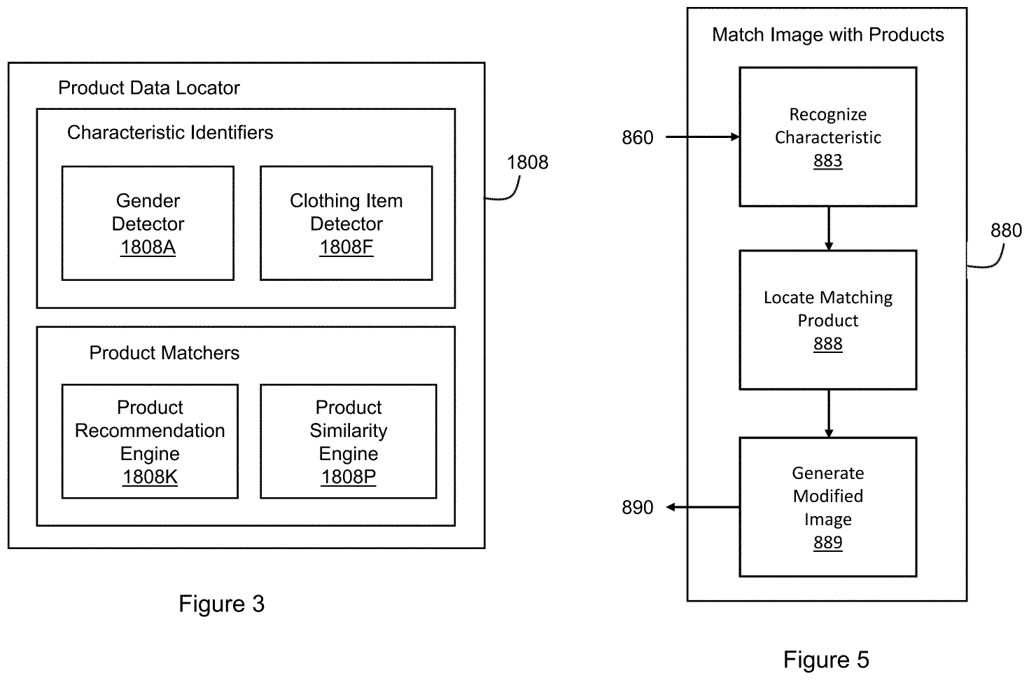

In addition to the above-mentioned functional components, the server processor 1800 is also configured to implement is a product data locator 1808 arranged to locate product data corresponding to at least one matching product based on the image automatically retrieved by the product server 18 from the image source 12. The product data locator 1808 comprises a number of functional sub-components in this embodiment. FIG. 3 is a schematic diagram of the sub-components.

As illustrated in the figure, the product data locator 1808 comprises image characteristic identifiers in the form of a gender detector 1808A and a clothing item detector 1808F, and product matchers in the form of a product recommendation engine 1808K and a product similarity engine 1808P.

The gender detector 1808F is configured to detect from a retrieved image a face and a gender of any person in the image. In this embodiment, the gender detector 1808F outputs product data in the form of coordinates of the detected face and a probability (which may be in percentage terms) of the detected gender (for example, to indicate the likelihood of the detected gender being correct). It is envisaged that the gender detector 1808F may output alternative product data. For example, it is envisaged that the gender detector 1808F may alternatively output simply a Boolean indicator that the detected gender is either female or not female.

The clothing item detector 1808F is arranged to detect one or more clothing items from the retrieved image. A person skilled in the art will appreciate that a clothing item may be a hat, a top, a pair of pants, some form of footwear etc. In this embodiment, the clothing item detector 1808F outputs product data in the form of information relating to the detected clothing item. It is envisaged that such information relating to a detected clothing item may include not merely information relating to the type of clothing item. For example, it is envisaged that the information relating to a detected bag may also include information that, in the image, the bag is being carried.

The clothing item detector 1808F may detect the one or more clothing items based on a face, a gender, or both a face and a gender detected by the gender detector 1808F. Also, the gender detector 1808F may detect a face, a gender, or both a face and a gender based on the one or more clothing items detected by the clothing item detector 1808F. The clothing item detector 1808F may not detect any clothing item from a retrieved image. Similarly, the gender detector 1808F may not always detect a gender and a face. For example, if the product data locator 1808 determines that the retrieved image comprises only an image of a footwear without any other imagery that might indicate a face and a gender, the gender detector 1808F may not detect any face, any gender, or both any face or any gender from the retrieved image.

In this embodiment, the data output by each of the gender detector 1808F and the clothing item detector 1808F is simultaneously output by the product server 18 for storage in association with the retrieved image. However, it is envisaged that the data output by either one of the gender detector 1808F and the clothing item detector 1808F may be output separately for storage.

The product recommendation engine 1808K is configured to locate and output product data corresponding to one or more recommended products based on the image retrieved by the product server 1800, the data output by each of the gender detector 1808F and the clothing item detector 1808F, and the formatted product data stored in the product database 16. That is, the product recommendation engine 1808K outputs a recommendation or recommendation of a product or products for each clothing item detected in an image. In this embodiment, the product recommendation engine 1808K does so by matching product images of products corresponding to the formatted product data stored by the product data formatter 1806 in the product database 16 against the image retrieved by the product server 18 based on any characteristics detected by the product data locator 1808 such as a gender detected by the gender detector 1808F. It is envisaged that the product recommendation engine 1808K can do this in different ways. For example, in one embodiment, the product recommendation engine 1808K may do this for each clothing item detected by the clothing item detector 1808F, by cropping a section or portion of the retrieved image corresponding to the detected clothing item, and then matching product images stored in the product database 16 against the specifically cropped section of the item in consideration.

The product similarity engine 1808P is configured to locate and output product data corresponding to one or more similar products. In this embodiment, the product data located by the product similarity engine 1808P is based on the one or more recommended products located by the product recommendation engine 1808K. However, it is envisaged that the product data may be located in an alternative manner. For example, it is envisaged that the product data may correspond to products that are less similar to recommended products and that can alternatively be located based on the retrieved image. Accordingly, depending on the embodiment, product data located by the product similarity engine 1808P may be output separately from product data located by product recommendation engine 1808K such that any similar product that is displayed to a user of a user device 19 may be displayed only after a recommended product is displayed to the user on the user device 19.

It is envisaged that, in an alternative embodiment of the distributed product locating system, the product data locator 1808 may not include all of the gender detector 1808A, the clothing item detector 1808F, the product recommendation engine 1808K and the product similarity engine 1808P. For example, it is envisaged that the product data locator 1808 of an alternative embodiment of the distributed product locating system may include merely the clothing item detector 1808F and the product recommendation engine 1808K.

In addition to the product data locator 1808, the server processor 1800 is also configured to implement a modified image generator 1803 that is arranged to generate a modified image comprising at least one selectable portion corresponding respectively to product data corresponding to one or more of the at least one matching (that is, either recommended or similar) product. Specifically, the modified image generator 1803 generates a modified copy of the retrieved image where each section or portion of the image cropped by the product recommendation engine 1808K can be selected by a user of a user device 19 to display information product or products that matches the cropped section or portion.

The transceiver controller 1809 of the product server is configured to control the server transceiver to 1890 to output product data located by the product data locator 1808 to a user device 19 from which an identifier is received. In this embodiment, the transceiver controller 1809 is configured to control the transceiver 1890 of the server 18 to also output the modified image generated by the modified image generator 1803 when outputting the product data to the user device 19 from which the identifier is received. However, it is envisaged that an alternative embodiment of the distributed computing system 10 may not involve outputting a modified image simultaneously with the product data, or at all.

In this embodiment, each of the transceiver 1890 of the server 18 and the transceiver 1990 of the user device 19 comprises both a transmitter and receiver. However, a person skilled in the art will appreciate that the product server 18, the user device 19 or both the product server 18 and the user device 19 may alternatively have an independent transmitter and an independent receiver.

Also, it is envisaged that the processor 1800 of the product server 18 may implement separate functional components for performing the operations performed by the transceiver controller 1809, in addition to or as an alternative to the above-mentioned transceiver controller 1809. For example, as an alternative to the above-mentioned transceiver controller 1809, the processor 1800 may implement an image retriever configured to control the transceiver 1890 of the product server 18 to retrieve an image corresponding to received image data from an image source 12 based on the received image data, and a product data transmitter configured to control the transceiver 1890 of the product server 18 to transmit product data corresponding to at least one product to the one of the plurality of user devices 19 in order to enable the one of the plurality of user devices 19 to display information relating to the at least one product.

It is envisaged that the distributed computing system 10 may alternatively involve locating products based on images from platforms other than social networking systems such as Instagram (trade mark). An example of such other platforms include messaging platforms. Also, it is envisaged that the program scripts may be implemented using programming other than JavaScript. For example, the program scripts may alternatively or additionally be implemented using PHP, Ajax, jQuery etc.

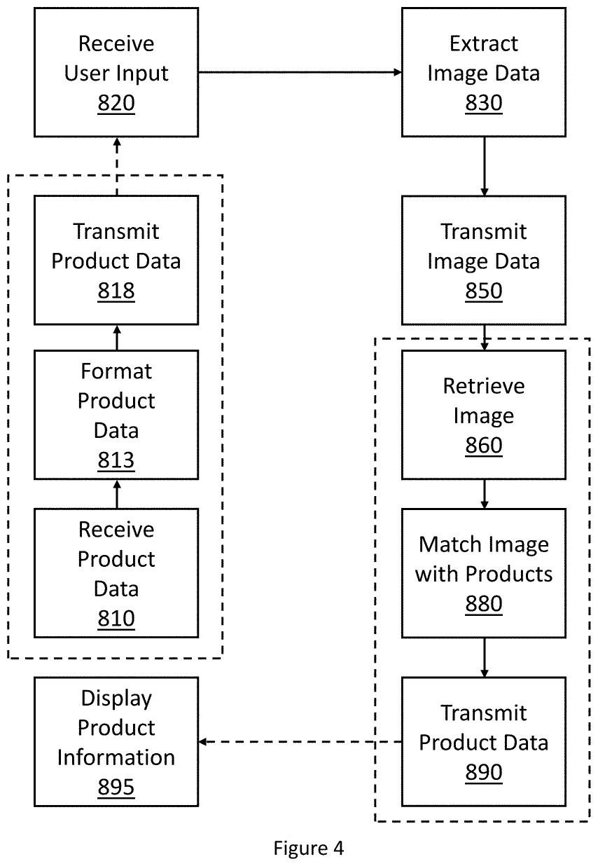

FIG. 4 is a flow chart of an embodiment of the method of locating products, carried out using the distributed computing system 10 of FIGS. 1, 2 and 3. Firstly, steps are performed by the product server 18 to collect product data. It is envisaged that these product data collecting steps may be performed before and while products are being located. At step 810, the server transceiver 1890 of the product server 18 receives product data from one of the plurality of external computing systems 11. At step 813, the product data formatter 1806 implemented by the processor 1800 of the product server 18 formats the product data received from the external computing system 11. At step 818, the server transceiver controller 1809 implemented by the processor 1800 of the product server 18 controls the server transceiver 1890 to transmit the formatted data from the product server 18 to the product database 16 for storage.

After or while product data is collected by the product server 18, any one of the user devices 19 may receive a request to locate products. At step 820, the user input receiver 1903 implemented by the processor 1900 of a user device 19 receives a user input that is made by a user on the user input device 1930 of the user device 19. Specifically, the user input is to share with the product server 18 an image that is displayed on the display 1950 of the user device 19. At step 830, the image data extractor 1908 implemented by the processor 1900 of the user device 19 extracts an identifier of the image. The identifier is a URI or URL of the image that is received by the transceiver 1990 of the user device 19 from an image data source 13 before the URI or URL is used to display the image on the display 1950 of the user device 19. At step 850, the transceiver controller 1909 implemented by the processor 1900 of the user device 19 controls the transceiver 1990 of the user device 19 to transmit the URI or URL to the product server 18.

It is envisaged that more than one of the user devices 19 of the distributed computing system 10 may receive a user input to share an image at the same time, and that the product server 18 is configured to locate products for multiple user devices 19. That is, multiple ones of the user devices 19 may simultaneously performed the steps 820 to 850.

Upon receiving an identifier of an image from the user device 19, the product server 18 performs steps 860 to 890 in order to locate matching products. At step 860, the server transceiver controller 1809 implemented by the processor 1800 of the product server 18 controls the transceiver 1890 of the product server 18 to retrieve the image from the image source 12 based on the received identifier in response to receiving the identifier from the user device 19. At step 880, the product data locator 1808 implemented by the processor 1800 of the product server 18 performs a matching operation 880.

FIG. 5 illustrates an embodiment of the matching operation 880. That is, FIG. 5 is a flow chart of specific steps that may occur when performing the matching operation 880. At step 883, one or both of the two characteristic identifiers of the product data locator 1808 recognizes at least one characteristic from the retrieved image. For example, one of the two characteristic identifiers in the form of the gender detector 1808A implemented by the processor 1800 of the product server 18 may detect a gender from the retrieved image. Alternatively (or additionally), the other one of the two characteristic identifiers in the form of the clothing item detector 1808F implemented by the processor 1800 of the product server 18 may detect one or more clothing items from the retrieved image.

It is envisaged that detection of the gender by the gender detector 1808A may be based on the clothing items detected by the clothing item detector 1808F, or that detection of the clothing items by the clothing item detector 1808F may be based on the gender detected by the gender detector 1808A.

Based on the recognized characteristic or characteristics, the product data locator 1808 locates at least one matching product using one or both of the two product matchers of the product data locator 1808 and the product data collected or stored in the product database 16 at step 888. Firstly, the product recommendation engine 1808 of the two product matchers matches product images of products corresponding to the formatted product data previously stored by the product data formatter 1806 in the product database 16 in step 818 against the image retrieved by the product server 18 in step 860 based on the characteristics detected by the product data locator 1808 such as gender. Optionally, the product similarity engine 1808P of the two product matchers locates a product or products that are similar to one or more of the matching products located by the product recommendation engine 1808K. At step 889, the modified image generator 1803 implemented by the processor 1800 of the product server 18 generates a modified image comprising at least one selectable portion corresponding respectively to product data corresponding to one or more of the at least one matching (that is, either recommended or similar) product. It is envisaged that an alternative embodiment of the method of locating products does not involve generating modified images as described above.

Turning now back to FIG. 4, at step 890, the transceiver controller 1809 of the product server 18 controls the transceiver 1890 of the product server 18 to transmit product data corresponding to the at least one matching products to the user device 19 that previously transmitted the image data to the product server at step 850. As indicated above, depending on the embodiment, a modified image may also be transmitted to the product server 18.

At step 895, the display controller 1905 implemented by the processor 1900 of the user device 19 that previously transmitted the image data to the product server at step 850 controls the display 1950 to display information relating to one or more of the at least one matching (that is, recommended, similar, or both recommended and similar) product based on the product data from the product server 18. It is envisaged that the displayed information may include information other than the product data from the product server 18. For example, the displayed information may include information that is separately retrieved by the user device 19 from the product database 16 or an external computing system such as one of the retail computing systems 11.

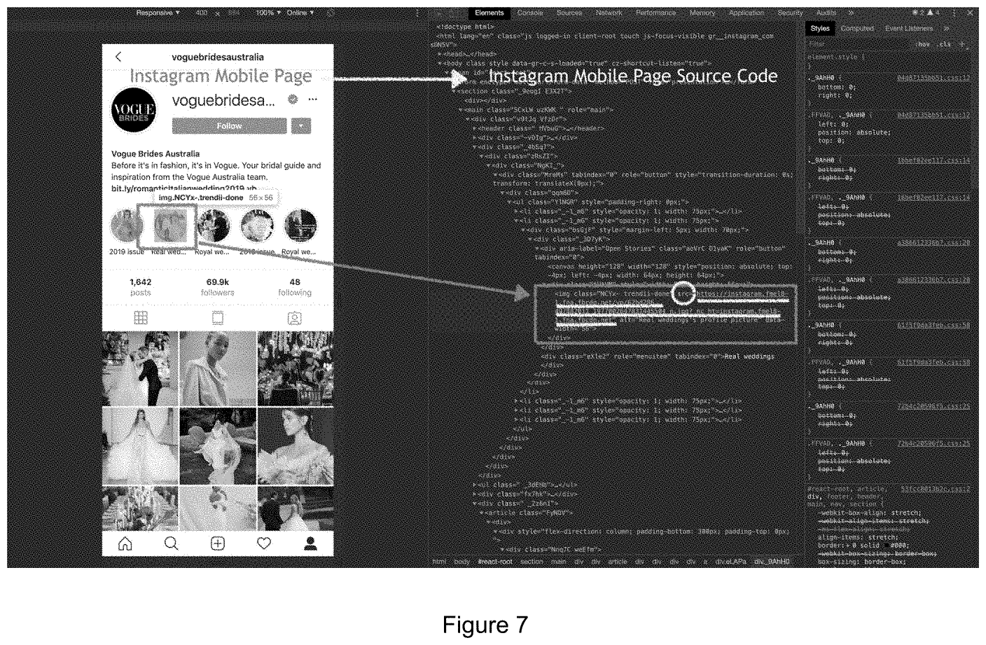

FIG. 7 is a flow chart of an embodiment of a method of collecting product data and an embodiment of the method of locating matching products, that may be carried out using the distributed computing system 10 of FIGS. 1, 2 and 3. In this embodiment, the distributed computing system 10 allows shoppers to browse and look for products based on user generated content such as community user upload photos that may emphasis on clothing and accessories that community users are wearing. It is envisaged that such community user upload photos may inspire users to look for products that match what users are wearing in the photo. Thus, the distributed computing system 10 enables inspired users to find products that match the ones the inspired users like in user generated photos.

### Product Database

As illustrated in the figure, there may be a number of retailers that provide product feeds into the distributed computing system 10. Source of each of these feeds could be any direct retailer, affiliate market or marketplace (such as Amazon (trade mark), Rakuten (trade mark)) and Farfetch (trade mark)), etc. These product feeds provide details (like image link, name, category, etc.) of each product the retailers sell online. The feeds are parsed into standard categories and all product details to be stored in the database are normalised. Each product is tagged to a category based on a number of logics and multiple fields of product data.

Product images are downloaded and stored by the distributed computing system 10 for use by a product recommendation engine 1808K and a product similarity engine 1808P.

### Gender Detection

The distributed computing system 10 detects face and gender in user generated content. As indicated above, such detection may include coordinates of a face and gender probability (which may be measured in percentage terms), but it will be appreciated that not all images necessarily have face and gender detected. For example, there is no face and gender detection in respect of the image of a footwear, as previously described above.

### Clothing Item Detection

As a user's image may have multiple clothing items, multiple clothing items may be detected by the distributed computing system 10 for storage against the user's image. Product Recommendation Engine

For each clothing item detected in an image with gender in consideration, the product recommendation engine 1808K of the distributed computing system 10 recommends ‘n’ number of products to users. The product recommendation engine 1808K uses product images and matches the product images against the user image, specifically a cropped section of each item of the user image in consideration.

### Product Similarity Engine

Each product shown to user by the product recommendation engine 1808K is then used by the product similarity engine 1808P of the distributed computing system 10 to show other similar products. The product similarity engine 1808P, like the product recommendation engine 1808K, is based on image matching, except the product similarity engine 1808P uses one product's image against ‘n’ other product images in the product database 16 to show similar products.

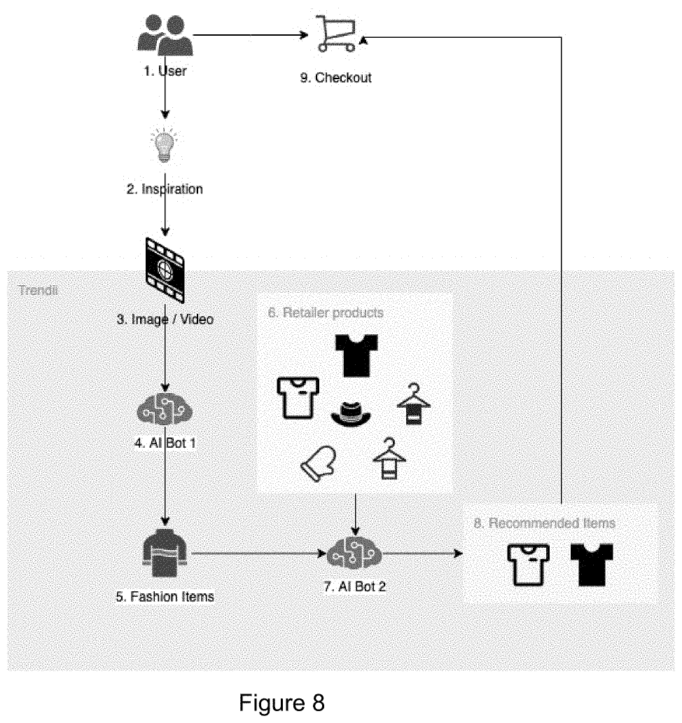

FIG. 8 is a flow chart of a method of making online purchases of products involving an embodiment of the method of locating matching products, that may be carried out using the distributed computing system 10 of FIGS. 1, 2 and 3.

At step 1, an Instagram (trade mark) user gets a fashion inspiration. In this respect, it is envisaged that users may get fashion inspirations at anytime and anywhere, for example, when they are walking on the street, browsing websites or social networks etc.

For example, at step 2, when a user is browsing Instagram (trade mark) and inspired by a fashion design from one of an image and a video from one of the user's influencers, that user may like to shop that design immediately.

At step 3, that user may then share the image or the video of the cloth inspirations from any user device (which may be via a mobile app, a mobile or a laptop camera, or a web browser) to the product server 18. For example, the user may take a photo and select an icon to share the captured image from Instagram (trade mark) directly with the product server 18 without providing any additional information.

Then, at step 4, the distributed computing system 10 performs the following product data collection (or fashion detection) algorithm (or Artificial Intelligence (AI) algorithm) based on settings on the cloud (that is, the product server 18 and the product database 16) or embedded in user devices, upon the product server 18 receiving the image or the video from a user to identify all clothes or fashion items in the image or the video:

1. Resize and optimize the received image or the received video

2. Detect all fashion items in the received image or the received video

3. Create separated pictures for all detected items and list them to the user

4. Then, the user can select any one of those items to explore further

At step 5, the identified the items are shown to the user and the user then chooses any specific item from the list for product matching.

At step 6, data pipelines of the distributed computing system 10 on the cloud are continuously gathering and updating fashion product images and details from different retailers. This includes:

1. Ingesting data to cloud storage through data feed or API

2. A process of data cleaning and validation that is triggered once the data lands

3. Cleaned data then being saved in the product database 16

4. Continuously monitor and validate ingested product links are working as expected on certain interval (secs to mins).

1. Generating all meta data from the item photo, for example, colour, size, style, design, cloth type etc.

2. Considering the meta data as part of the inputs and finding similar products in product pool.

3. Combining with a user's meta data (such shopping behaviour) to further personalise product recommendation for users.

At step 8, the distributed computing system 10 generates a list of recommended products and send the list back to user for enabling the user to shop for any of the listed products. For example, a list of products similar to those found in an Instagram (trade mark) influencer's photo may be sent back to a user.

At step 9, a user checkouts and completes shopping for any product. For example, a user gets a list of products similar to those found in a photo the user previously provided to the distributed computing system 10 and then completes shopping.

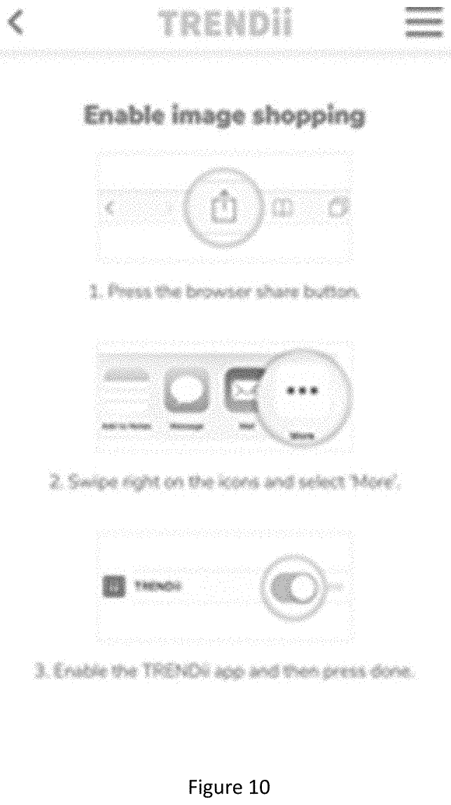

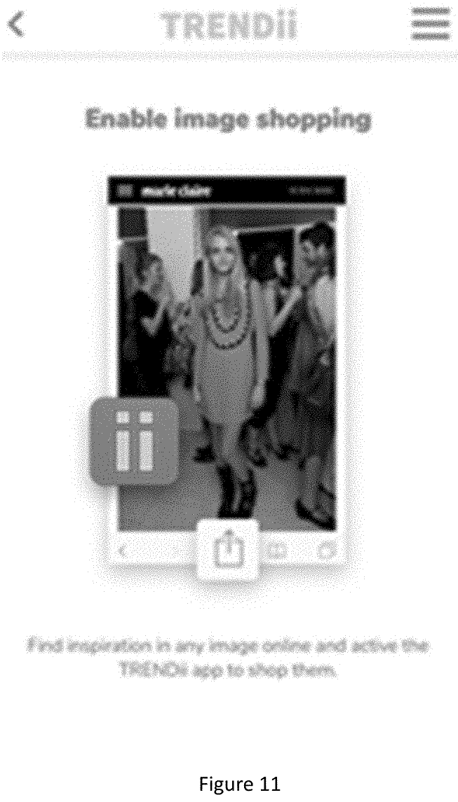

FIGS. 10 and 11 are screenshots of a user device of an embodiment of the distributed computing system 10 of FIGS. 1, 2 and 3. Specifically, the figures show how a user may enable image shopping from different mobile apps installed on a user device 19 and subsequently use the smartphone all to share images (that is, to share image URL data) with the product server 18 of the distributed computing system 10.

As illustrated in FIG. 10, the user must first install a mobile app on the user device 19 to enable image sharing from the user device 19. Then, any one of different mobile apps with a sharing function may then be used to share a page (in particular, one with image) with the product server 18 through the mobile app. Once such sharing function is used, the mobile app installed on the user device will then parse the URL from that page.

As illustrated in FIG. 11, the user may choose to take a picture using a mobile camera app or select an image from a mobile app displaying a gallery of captured images or screenshots. Any such captured or selected image may be directly loaded and shared with the distributed computing system 10 in image formats such as a Portable Network Graphics (PNG) format and a Joint Photographic Experts Group (JPEG) format.

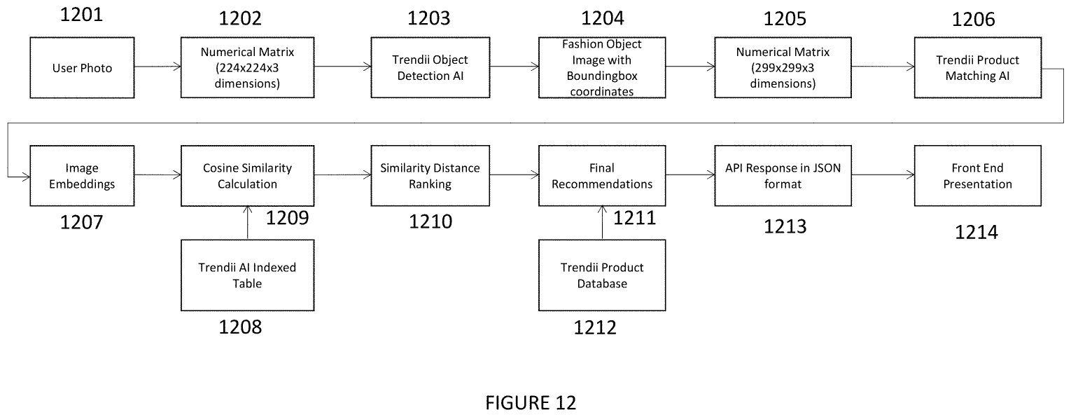

FIG. 12 is a flow diagram of a further method for recommending products to a user based on a fashion inspiration image provided by a user, that may be carried out using the distributed computing system 10 of FIGS. 1, 2 and 3.

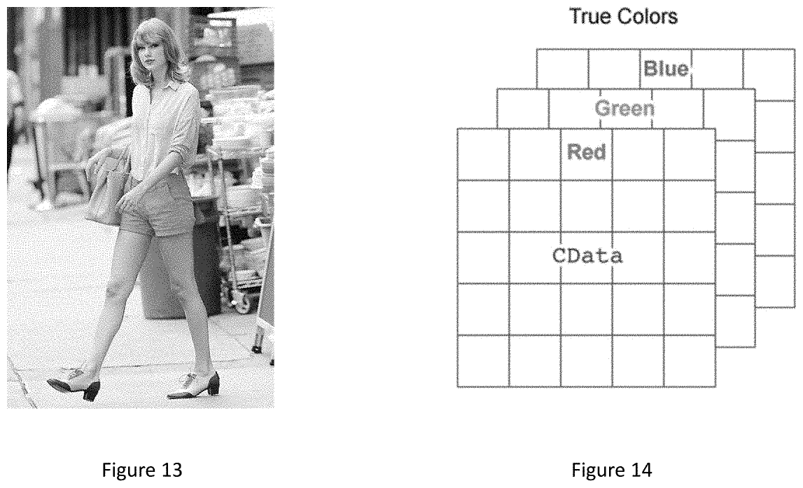

At 1201 a fashion inspiration image is retrieved by the product server 18. The fashion inspiration image is typically a photograph including at least one fashion object. An example of an image retrieved by the product server is shown in FIG. 13. In the example of FIG. 13 the image is a photograph of a female and includes multiple objects including shoes, shorts, shirt, bag. The product server may retrieve the fashion image using different methods. As discussed previously, when the transceiver controller 1809 receives an identifier (that is, a URL) of an image from a user device 19 the transceiver controller 1809 is configured to control the server transceiver to automatically retrieve the image from the image source 12 via the Internet 15. Alternatively, transceiver controller 1809 may receive an image captured by a user mobile camera app or other user image capturing mechanism. The captured image may be in an image format such as a Portable Network Graphics (PNG) format and a Joint Photographic Experts Group (JPEG) format. The captured image is provided to the product server 18 by the user device 19.

At 1202 the image is provided to the modified image generator 1803. Modified image generator 1803 reformats the image for processing. Reformatting may include resizing and normalising the image. In an embodiment the image is reformatted into a 224×224×3 numerical metric array. The image may be resized into other dimensions based on model optimisation. Sizes other than 224×224×3 may be used. An example of the three component numerical metric arrays for the image is shown in FIG. 14. The purpose of reformatting the image is to convert all incoming images into to have predetermined dimensions preferred by the model used by the product server.

The next stage of the product recommendation process is executed by product data locator 1808 and is described with respect to steps 1203 to 1210 of FIG. 12.

At 1203 clothing item detector 1808F runs an algorithm on the reformatted 224×224×3 numerical metric array to identify and extract items in the image. The algorithm may be an AI algorithm. As discussed above, clothing item detector 1808F is configured to detect clothing items within the image. Product data locator is configured to identify clothing items within the image using an algorithm.

The algorithm is configured to scan the image to identify features that are important to identifying items in the image. For example, the algorithm may identify features of a shirt, including collar, round next, v-neck. These features include recognisable patterns of pixels which the algorithm is tuned to identify.

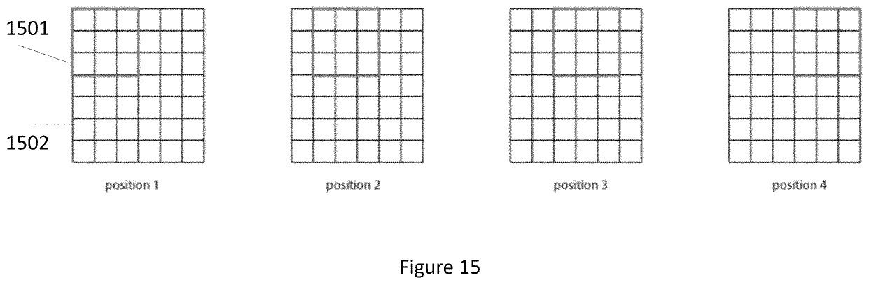

The scanning process of step 1203 is shown in FIG. 15. In the scanning process, clothing item detector 1808F scans cropped sections of the image in a sequence. For each cropped section the algorithm compares the subset of pixels within the cropped section with predefined patterns stored in memory 1880. In the example of FIG. 15, algorithm uses a scanning square having 3×3 pixels 1501. Different size scanning squares may be used. The clothing item detector 1808F moves the scanning square 1501 across the image in sequence, each time the scanning square is moved, a different combination of pixels of the image is captured within the scanning square 1501. In the sequence shown in FIG. 15, the scanning square 1501 starts in position 1. The combined 3×3 pixels within scanning square 1501 are compared with known features, represented by images or patterns stored within memory 1880, to identify any recognised items appearing within the scanning square.

After the pixels within the scanning square in position 1 have been analysed, scanning square 1501 is moved to a different position within the image to include a different combination of pixels. In the example of FIG. 15, scanning square is moved one pixel to the right into position 2. Again, the 3×3 pixels within scanning square are compared with known features stored within memory 1880 to identify whether any recognised items appear within the scanning square in position 2. The scanning square is then again moved across one pixel to the right into position 3 and so on. The scanning square 1501 is continued to be moved across and up and down throughout the image until all sections of the image have been evaluated.

An advantage of the embodiment is that the algorithm is scanning the image to extract image features that are important to identify items in the image. The size of the scanning square may vary depending on the algorithm and the dimensions. In the method described above, the scanning square is moved by a single pixel. Further embodiments may move the scanning square by multiple pixels. This may improve performance or efficiency of the algorithm. The scanning square may have different dimensions depending on the algorithm used.

When clothing item detector 1808F identifies a match between an image feature within the scanning square and a predefined pattern stored within memory 1880, the algorithm tracks the boundary of the item to define the section of the image which includes the item in order that the item can be identified within the image. For example, if the algorithm identifies features in the image that are consistent with a pair of shorts, it tracks across the image to identify the boundary of the shorts within the image. The clothing item detector 1808F records the boundary coordinates for the object within the image. A predication score associated with the matched item is also stored. The higher the prediction score, the better the match. The boundary box for the item is stored to identify the position of the object within the image.

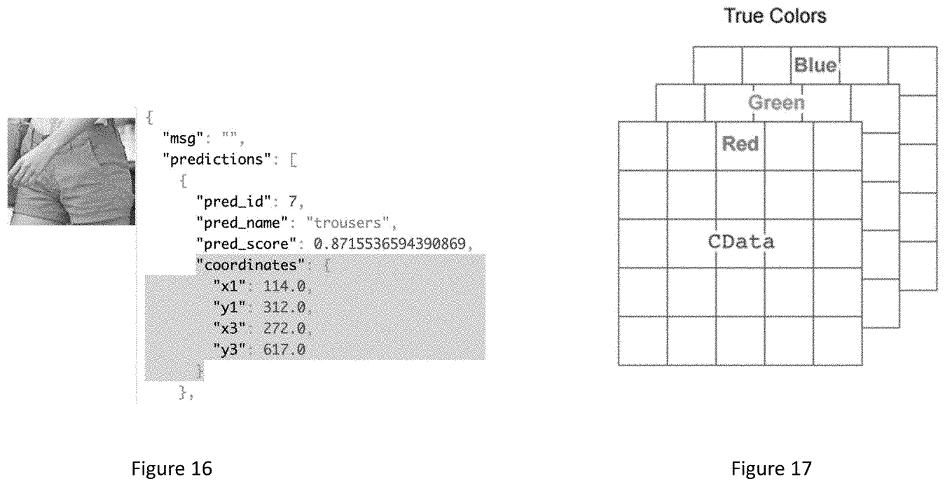

FIG. 16 shows an example of a detected item image from fashion inspiration image of FIG. 13 and the bounding box coordinates defining the detected item image. The item is a pair of orange shorts. In the example of FIG. 16, the predication ID is 7; Predication name is “trousers”; Predication Score is 0.8715536594390869. The position of the bounding box within fashion inspiration image is defined in terms of xy coordinates. Other coordinate systems may be used. The data associated with the detected item image may be stored in memory 1880.

Once an item has been detected within the image, clothing item detector attempts to match the item with product data within product database. This allows the system to identify and provide retail products to the user which match the clothing items detected within the image.

In order to match the identified object with products within the product database, the image within the boundary box is converted into a predetermined size. Clothing item detector 1808F converts the image at step 1205. The conversion process is generally similar to that described above with respect to step 1202. In the example of FIG. 16 the image is converted to a 299×299×3 image file. The image may be converted into any size and may be optimized depending on the model used by clothing item detector 1808F.

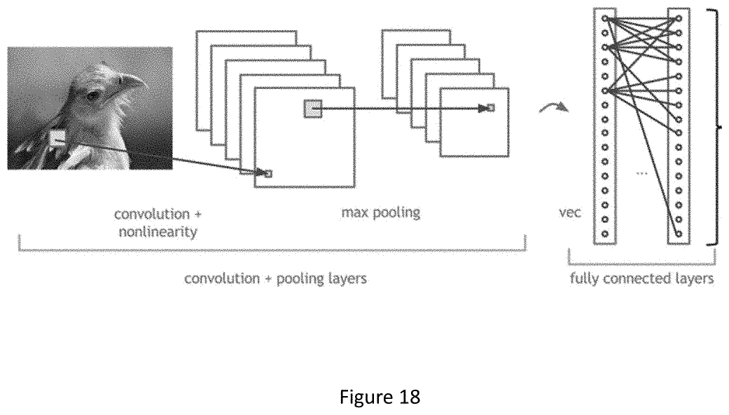

Product data locator 1808 is configured to identify products within product database which match the item identified within the bounding box. The process for matching products is performed by product data locator 1808 from 1206. Product data locator 1808 is configured to execute a product matching algorithm using the boundary box image received from the clothing item detector 1808F. The algorithm may be a deep learning algorithm based on convolutional neural networks. FIG. 18 shows a high level representation of the algorithm.

In the embodiment described in FIG. 12, the product data locator is configured to convert the image file and to compare the converted file to products in the database to identify matching products. In an embodiment the image file is converted into an embedding vector and uses the embedding vector to identifying matching products within product database 16. An advantage of using embedding vectors is to reduce computational complexity. The embedding vector is a representation with meaningful information about the image. The product data locator is configured to compare the embedding vector for the object with embedding vectors of products in the database to identify products in the product database which are most similar to the object in the image. Other techniques including SURF, SIFT, FAST algorithms may also be used.

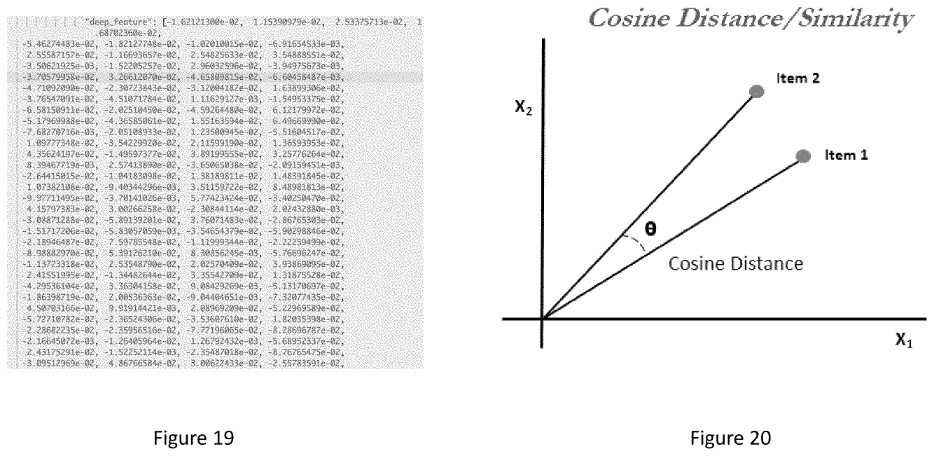

Product data locator 1808 is configured to convert the image file of boundary box into an embedding vector. At step 1207 the image file of the boundary box is converted into an embedding vector. Embedding vectors are one of the standard layers in deep learning models, often called Dense Layer or Fully-connected Layer. In the example the embedding vector is a vector including 1024 numbers. The numbers are generated from fully connected layers of the AI model and contain the most useful information relating to the object in the image. The embedding vector represents information about the object in the image including colour, clothing type, style. An example representation of the embedding vector is shown in FIG. 19.

Product database 16 is configured to store embedding vector representations of products within the product database. Product database is configured to create a embedding vector for the image of products stored in product database 16. The embedding vectors are used to compare with the embedding vectors of the image objects to match the objects of the image with products in the product database. The embedding vectors for the products in product database are created by running the same embedding algorithms on the product images. The product embedding vectors are indexed and product identification information is stored with the embedding vector file to identify the product represented by the embedded vector.

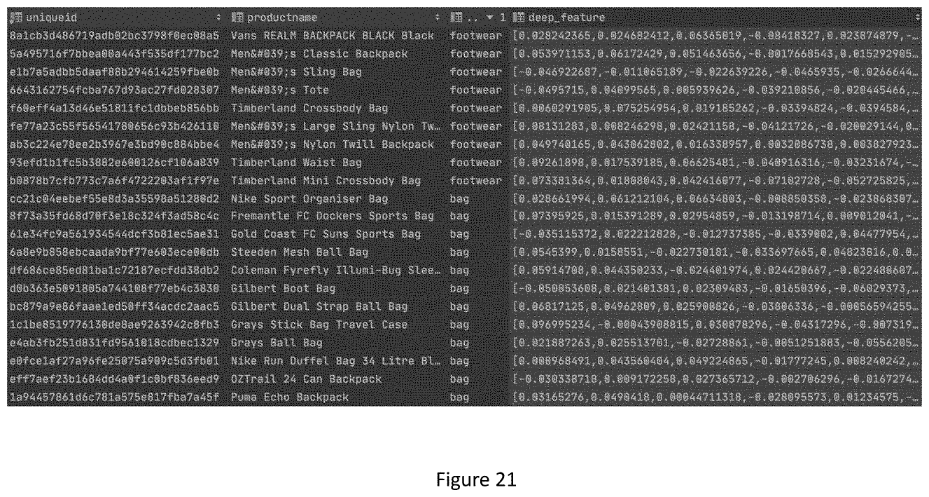

FIG. 21 shows an example of an indexed table including products of the product database and the embedding vector. Indexed table includes a unique identifier for each product; a product name; fashion category, including footwear, bag; and, the embedding vector (deep feature) for the product.

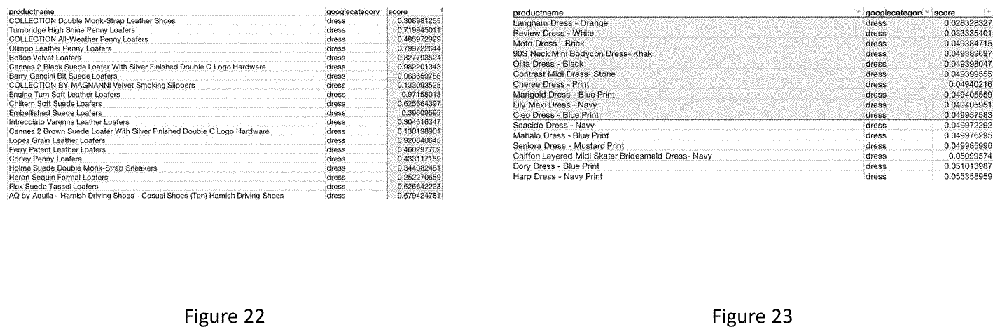

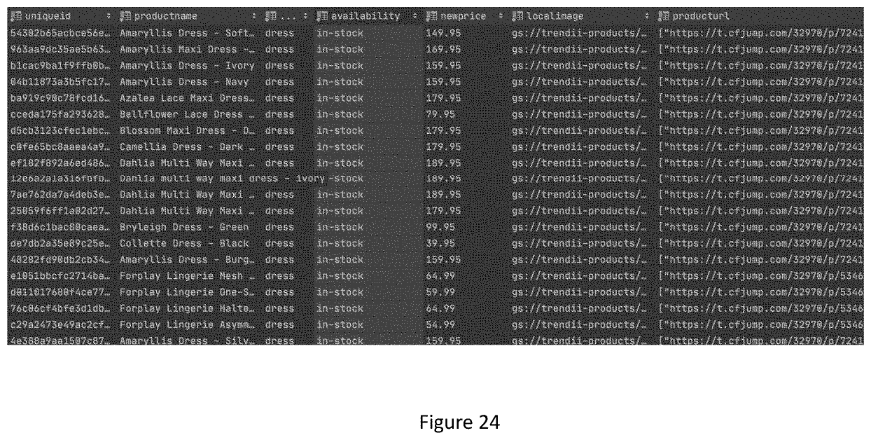

Product similarity engine 1808P is configured to compare image embedding with the embedding vectors of the products in the product database at 1209. At 1210 product data locator retrieves the embedding vectors for the products in the product database and compares the embedding vectors at 1209. Product data locator runs cosine similarity algorithm on the target image embedding vector with embedding vectors of the product database as shown in FIG. 20. The similarity score is stored for each object in the database, as shown in FIG. 22. In the cosine similarity algorithm, the smaller the angle between the embeddings the more similar the images. Other algorithms used for comparing the embeddings include Euclidean distance algorithm and Pearson Correlation. FIG. 22 shows the

Product data locator is configured to rank the products in order of similarity to the target object image at step 1211. The similarity distance between the target object image and the products within product database is used to rank the products, where the higher the ranking, the more similar the product to the target object image. FIG. 23 shows the products ranked in order of similarity to the identified object. Product data locator is configured to identify a predetermined number of the highest ranking products.

Product database is an aggregation of product data from multiple retailers. Some product databases may include products from hundreds of retailers. Product data stored in product database 16 is regularly updated. Retailers transmit updated product information to product database periodically. Updated information includes, for example, product availability. Product data stored within product database 16 may include URL link to retailer; images of the products; price information; product information; product availability.

Product recommendation engine 1808K is configured to retrieve product data for the most relevant products from product database 16 at 1212. These are the products with the highest similarity scores to the object in the bounding box. Typically the product data is retrieved using product ID. Product recommendation engine 1808K checks the highest ranking results against the product database to ensure the products are available with the retailers. Further product meta data including price, image URL, product page URL is also retrieved at 1212.

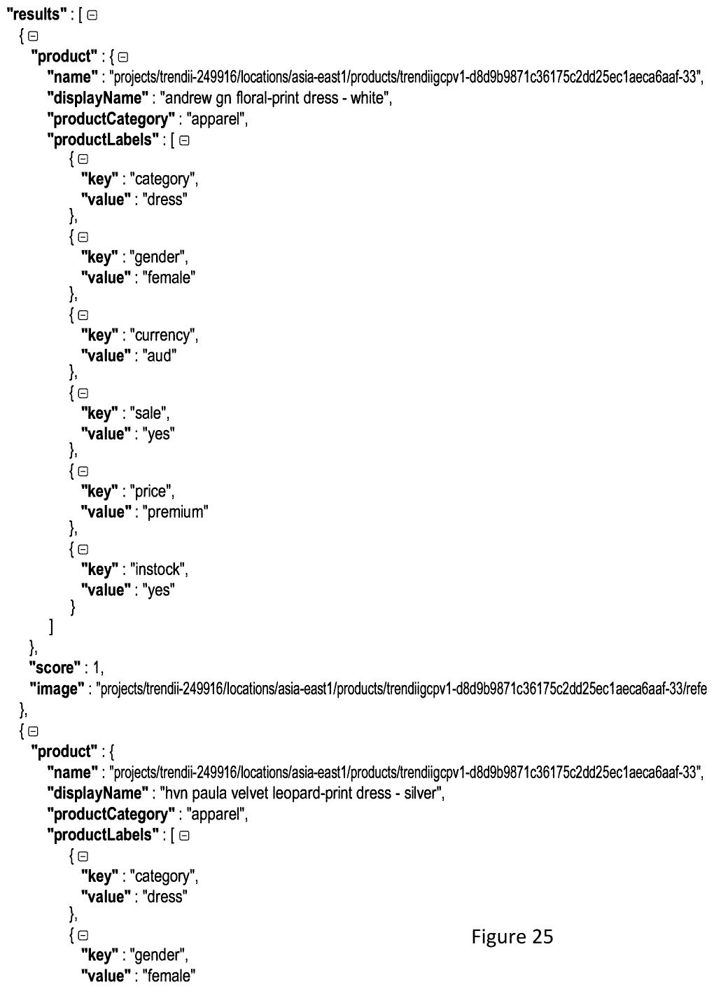

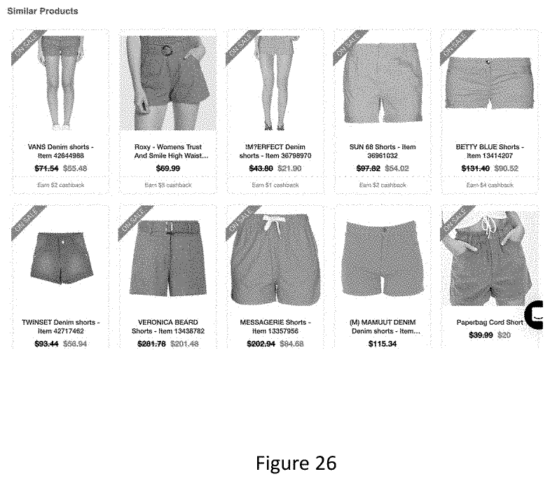

Product data locator 1808 is configured to compile the product details for the highest ranking products. Product recommendations are compiled as an API response to be sent back to the user in JSON text format at 1213. FIG. 25 shows an example of a JSON format of product recommendations sent back to the user. The data includes image URL, product labels, product category and other product information for the highest ranking products. Typically, product data locator is configured to send a predefined number of products.

Transceiver 1990 at user device is configured to receive the product data and present the product information to the user in the relevant UI. Typically, the URLs provide links to the product database of the aggregator. Within the product database, a user may be provided with a URL link to access the retailer site. FIG. 26 shows an example of a UI representation of recommended products. As shown in the figure, the UI provides multiple different products matching the object identified in the original image. In the example the server identified multiple orange female shorts available from retailers within the aggregated product database. The user is presented with images of the products; price information; product description. Selection of a product by the user, for example by clicking on the product image within the UI, will direct the user to the aggregator product page. The user may be able to purchase the product directly from the aggregator product page or may be directed to the retailer to purchase the product.

It will be clear from the above description that embodiments of the invention provide a server with capabilities to receive or retrieve an image and to identify objects within the image for comparison with products stored within a product database. The use of embedding vectors allows the most useful information retrieved about an object image to be used to compared with products stored within product database to identify the most similar products. The server is configured such that the product database is periodically updated with product information including availability of the product. Periodic updating of the product database provides the advantage that availability of products can be confirmed by the server before product recommendations are provided to users.

Embodiments are configurable with different settings and user preferences. For example, some settings may prevent unavailable products from being sent to users during recommendations. Other settings may enable the user to select the number of recommended products that are provided by the server.

Embodiments are configured to automatically detect fashion items from user provide images or user selected images and provide recommendations of products matching fashion items identified in the images from an aggregated database of retailer products.

As indicated above, an embodiment of the distributed computing system 10 is advantageous when compared to conventional product locating systems in that products can be located more directly based on an image (instead indirectly by way of keywords of the image) by a remote product server (rather than by each local user device displaying the image) which can more efficiently collect product data from significant number of retailers. As product data from retailers may be either sourced by such a distributed computing system 10 or provided by retailers, the distributed computing system 10 need not be tied to locating products from any particular retailer or retailers, such as only retailers that are actively providing product data to the distributed computing system 10.

Further aspects of the method will be apparent from the above description of the system. For example, it will be appreciated that the retail website provided by the retail computing system may alternatively be a mobile application (such as a smartphone app). Persons skilled in the art will also appreciate that the method could be embodied in program code. The program code could be supplied in a number of ways, for example on a tangible computer readable medium, such as a disc or a memory (for example, that could replace part of memory) or as a data signal (for example, by transmitting it from a server).

Similarly, it will be appreciated that the data in the product database and the user database can be supplied on any appropriate tangible data carrier, such as by writing them to a portable device (such as a USB drive), storing them in a memory (including transmitting identifiers to a device having a memory) etc.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference made herein to prior art is not intended to imply that such prior art forms or formed a part of the common general knowledge in Australia or any other country.

What is claimed is:

1. A distributed computing system (10) for locating products, comprising:
a plurality of user devices (19);
a product server (18) in communication over a network (15) with the plurality of user devices (19); and
a product database (16) storing product data corresponding to a plurality of products,
wherein each user device (19) is configured to:
receive a user input to share an image with the product server (18);
extract image data corresponding to the image from an image data source (13); and
transmit the extracted image data to the product server (18), and
wherein the product server (18) is configured to:
in response to receiving the image data from one of the plurality of user devices (19), retrieve the image from an image source (12) based on the received image data;
match the retrieved image with at least one of a plurality of products based on the product data stored in the product database (16); and
transmit product data corresponding to the at least one product to the one of the plurality of user devices (19) in order to enable the one of the plurality of user devices (19) to display information relating to the at least one product.

2. A system as claimed in claim 1, wherein the image data extracted by each user device (19) comprises an identifier of an image.

3. A system as claimed in claim 2, wherein the identifier is a Uniform Resource Locator (URL).

4. A system as claimed in claim 1, wherein each user device (19) is configured to retrieve an image from the image source (12) for display on a display of the user device (19).

5. A system as claimed in claim 1, wherein the image source (12) is an external computing system in communication over a network (15) with each user device (19).

6. A system as claimed in claim 1, wherein the product server (18) is in communication with a plurality of external computing systems (11), and is configured to receive product data from each of the plurality of external computing systems (11).

7. A system as claimed in claim 6, wherein the product server (18) is configured to index the product data received from the plurality of external computing systems (11).

8. A system as claimed in claim 1, wherein the product server (18) is configured to recognize at least one characteristic from the retrieved image, and
wherein the retrieved image is matched with the at least one of the plurality of products based on the at least one characteristic.

9. A system as claimed in claim 1, wherein the product server (18) is configured to generate a modified image comprising at least one selectable portion corresponding respectively to the at least one product.

10. A method of locating products, comprising:
receiving a user input at one of a plurality of user devices (19) to share an image with a product server (18) in communication over a network (15) with each user device (19);
extracting image data corresponding to the image from an image data source (13);
transmitting the image data from the one of the plurality of user devices (19) to the product server (18);
in response to receiving the image data, retrieving the image from an image source (12) based on the received image data;
matching the retrieved image with at least one of a plurality of products based on product data corresponding to a plurality of products stored in a product database (16); and
transmitting product data corresponding to the at least one product to the one of the plurality of user devices (19) in order to enable the one of the plurality of user devices (19) to display information relating to the at least one product.

11. A method as claimed in claim 10, wherein the image data transmitted by each user device (19) comprises an identifier of the image that is determined by the user device (19).

12. A method as claimed in claim 11, wherein the identifier is a Uniform Resource Locator (URL).

13. A method as claimed in claim 10, wherein the method comprises retrieving an image from the image source (12) for display on a display of the user device (19).

14. A method as claimed in claim 10, wherein the image source (12) is an external computing system in communication over a network with each user device (19).

15. A method as claimed in claim 10, wherein the product server (18) is in communication with a plurality of external computing systems (11), and
wherein the method comprises receiving product data from each of the plurality of external computing systems (11).

16. A method as claimed in claim 15, wherein the method comprises indexing the product data received from the plurality of external computing systems (11).

17. A method as claimed in claim 10, wherein the product server (18) is configured to recognize at least one characteristic from the retrieved image, and
wherein the retrieved image is matched with the at least one of the plurality of products based on the at least one characteristic.

18. A method as claimed in claim 10, wherein the product server (18) is configured to generate a modified image comprising at least one selectable portion corresponding respectively to the at least one product.

19. A product server (18) for locating products, comprising:
a transceiver (1890);
a processor (1800);
a memory (1880) storing executable code that when executed by the processor (1800) causes the product server (19) to:
receive, via the transceiver (1890), from one of a plurality of user devices (19) in communication over a network (15) with the product server (18) image data extracted from an image data source (13);
retrieve, via the transceiver (1890), an image corresponding to the received image data from an image source (12) based on the received image data;
match the retrieved image with at least one of a plurality of products based on product data stored in a product database (16) in communication with the product server (18); and
transmit, via the transceiver (1990), product data corresponding to the at least one product to the one of the plurality of user devices (19) in order to enable the one of the plurality of user devices (19) to display information relating to the at least one product.

20. A user device (19) for locating products, comprising:
a user input device (1930);
a user display (1950);
a transceiver (1990);
a processor (1900);
a memory (1980) storing executable code that when executed by the processor (1900) causes the user device (19) to:
receive, via the user input device (1930), a user input to share an image with a product server (18) in communication over a network (15) with the user device (19);
in response to receiving the user input, extract image data for enabling the product server (18) to retrieve image from an image source (12), wherein the image data corresponds to the image; and
transmit, via the transceiver (1990), the extracted image data to the product server (18);
receive, via the transceiver (1990), from the product server (18) product data that is generated based the transmitted image data, wherein the product data corresponds to at least one product matching the image; and
in response to receiving the product data, display information relating to the at least one product on the user display (1950).
